(19) United States
(12) Patent Application Publication
(10) Pub. No.: US 2017/0103121 A1
(43) Pub. Date: Apr. 13, 2017

(54) DRIVE SUPPORT APPARATUS

(71) Applicant: DENSO CORPORATION, Kariya-city (JP)

(72) Inventors: Masataka Mori, Kariya-city (JP); Kazuhito Takenaka, Kariya-city (JP); Takashi Bando, Kariya-city (JP)

(21) Appl. No.: 15/285,235

(22) Filed: Oct. 4, 2016

(30) Foreign Application Priority Data
Oct. 8, 2015 (JP) 2015-200145

(51) Int. Cl. G06F 17/30; G09B 9/042

(52) U.S. Cl. CPC G06F 17/30601; G06F 17/30589; G06F 17/30327; G09B 9/042

(57) ABSTRACT

A drive support apparatus includes a data collection part that collects driving behavior data of drivers, a classification part that performs clustering of the driving behavior data to form small clusters, an integration part that integrates, in accordance with contents of predetermined drive supports, the small clusters to thereby form support clusters each showing tendency of driving behavior of the drivers for each kind of the drive supports, an object data acquisition part that acquires, as object data, the driving behavior data regarding a support object driver to be supported, an estimation part that estimates, as a belonging cluster, one of the support clusters to which the support object driver belongs for each kind of the drive supports by comparing the object data with the support cluster information accumulated by the integration part.

This application claims priority to Japanese Patent Application No. 2015-200145 filed on Oct. 8, 2015, the entire contents of which are hereby incorporated by reference.

### BACKGROUND OF THE INVENTION

1. Field of the Invention

The present invention relates to a technique for implementing individual driver-oriented drive support.

2. Description of Related Art

Japanese Patent Application Laid-open No. 2013-164748 describes an apparatus configured to detect drowsiness of a driver, and provide drive support in accordance with the detection result. This apparatus classifies drivers into groups in accordance with usual eye opening degree, and sets a determination threshold for each group to correctly determine drowsiness of a driver of each group.

The drive support provided by the above described conventional apparatus that classifies drivers into groups in accordance with usual eye opening degree is very limited, and it is difficult to use the results of the classification for other kind of drive support.

### SUMMARY

An exemplary embodiment provides a drive support apparatus including:

a data collection part that collects, as driving behavior data, data showing driving maneuvers performed by drivers and data showing vehicle behaviors due to the driving maneuvers;

a classification part that performs clustering of the driving behavior data to form small clusters to each showing tendency of driving behavior of the drivers belonging thereto, and stores small cluster information representing characteristics in driving behavior of the drivers for each of the small clusters;

an integration part that integrates, in accordance with contents of predetermined drive supports to control a vehicle or to control devices mounted on the vehicle, the small clusters to thereby form support clusters each showing tendency of driving behavior of the drivers for each kind of the drive supports, and stores, as support cluster information, the small cluster information for each of the support clusters;

an object data acquisition part that acquires, as object data, the driving behavior data regarding a support object driver to be supported;

an estimation part that estimates, as a belonging cluster, one of the support clusters to which the support object driver belongs for each kind of the drive supports by comparing the object data with the support cluster information accumulated by the integration part; and

a support providing part that provides the support object driver with at least one of the drive supports which has a content associated to the belonging cluster.

According to the exemplary embodiment, there is provided a drive support apparatus capable of providing an exact drive support to a driver in a variety of driving scenes.

Other advantages and features of the invention will become apparent from the following description including the drawings and claims.

### BRIEF DESCRIPTION OF THE DRAWINGS

In the accompanying drawings:

FIG. 1 is a block diagram showing the structure of a drive support apparatus according to an embodiment of the invention;

FIG. 2 is a diagram for explaining a relationship between driving behavior data and drive codes;

FIG. 3 is a flowchart showing steps of a small cluster forming process;

FIG. 4 is a flowchart showing steps of a support cluster forming process;

FIG. 5 is a diagram for explaining progress and result of hierarchical clustering;

FIG. 6 is a flowchart showing steps of a hierarchical decision process;

FIG. 7 is a diagram exemplifying contents of classification requirement of a first type;

FIG. 8 is a diagram exemplifying contents of classification requirement of a second type;

FIG. 9 is a diagram exemplifying a relationship between hierarchized clusters and a feature distribution;

FIG. 10 is a flowchart showing steps of a correspondence decision process;

FIG. 11 is a diagram exemplifying a relationship between support clusters and support modes;

FIG. 12 is a diagram exemplifying a relationship between a feature distribution of a support target driver and a standard model of a belonging cluster; and

FIG. 13 is a diagram showing a simulation result of the hierarchical clustering.

### PREFERRED EMBODIMENTS OF THE INVENTION

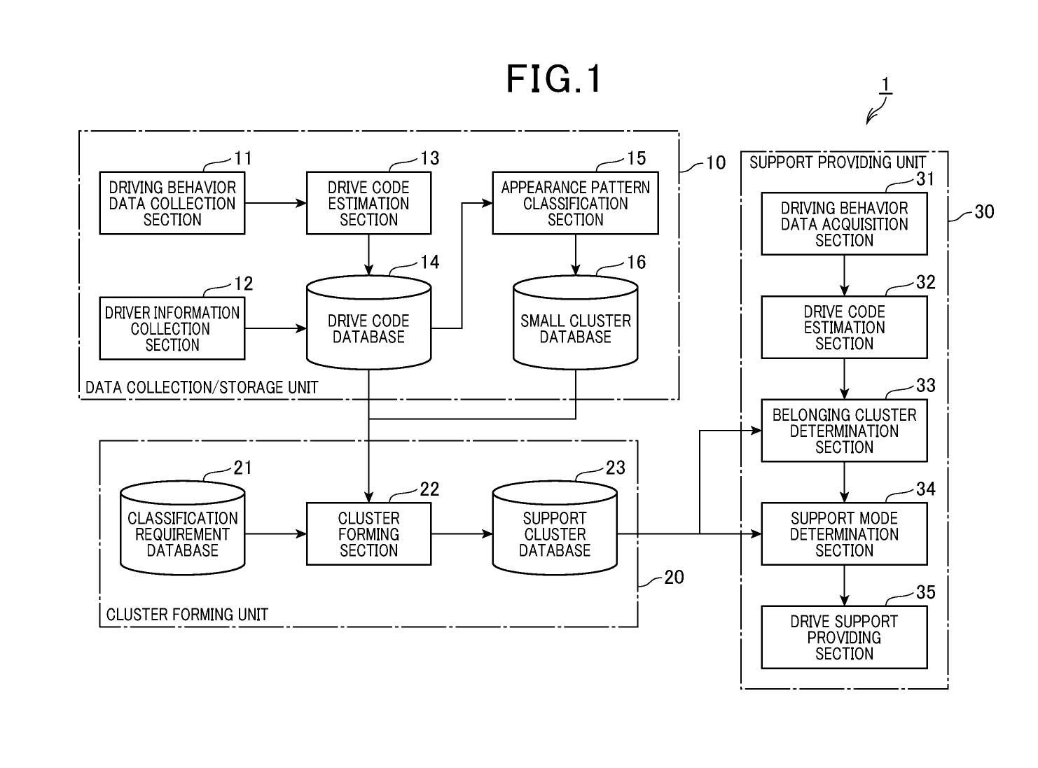

FIG. 1 is a block diagram showing the structure of a drive support apparatus 1 according to an embodiment of the invention. The drive support apparatus 1 includes a data collection/storage unit 10, a cluster forming unit 20 and a support providing unit 30. The support providing unit 30 is mounted on each of vehicles to be supported. Each of the data collection/storage unit 10 and the cluster forming unit 20 is constituted as a server connected to a communication network to communicate with each of the vehicles on which the support providing unit 30 is mounted. The data collection/storage unit 10 and the cluster forming unit 20 may be integrated as one unit. Alternatively, they may be disposed separately from each other so as to communicate with each other through the communication network.

Each of the data collection/storage unit 10, the cluster forming unit 20 and the support providing unit 30 is implemented as a microcomputer-based unit. Functions or methods of various sections of these units are implemented by programs stored in a non-transitory physical storage medium (referred to as a memory hereinafter) executed by a CPU of a microcomputer. FIG. 1 shows functional blocks implemented by the programs stored in the memories, which correspond to the functions implemented by the CPUs or information used by the CPUs. However, the functions of the various sections do not necessary have to be implemented by software. Part or all of them may be implemented by hardware including combinations of logic circuits and analog circuits.

The data collection/storage unit 10 includes a driving behavior data collection section 11, a driver information collection section 12, a drive code estimation section 13, a drive code database 14, an appearance pattern classification section 15 and a small cluster data base 16. The driving behavior data collection section 11, the drive code estimation section 13 and the drive code database 14 constitutes a data collection part. The appearance pattern classification section and the small cluster data base 16 constitute a classification part.

The driving behavior data collection section 11 collects, as driving behavior data, data showing driving maneuvers performed by drivers, and data showing vehicle behaviors due to the driving maneuvers. The driving behavior data collection section 11 further collects position information and time information showing positions and times at which these data are collected. Such driving behavior data, which are represented as continuous time-series data for each trip from engine start to engine stop, are collected in large quantities through communications with an unspecified large number of vehicles provided with the function to communicate with the data collection/storage unit 10.

The data showing driving maneuvers performed by drivers include an operation amount of an accelerator pedal, an operation amount of a brake pedal, an operation amount of a steering wheel, an operation state of a direction indicator, a shift position of a transmission and so on. The data showing vehicle behaviors include a speed, an acceleration, a yaw rate of each vehicle and so on. The driving behavior data may include derivatives of such data.

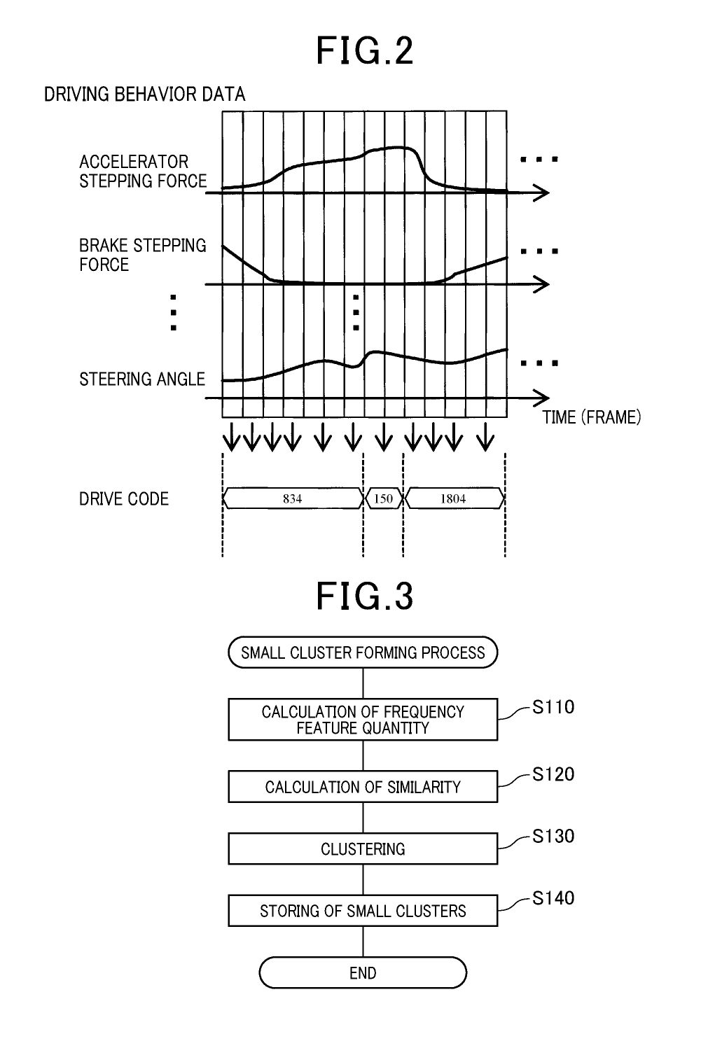

The driver information collection section 12 collects age, sex, driving experience, a residential area and so on of each driver together with the driving behavior data collected by the driving behavior data collection section 11. As shown in FIG. 2, the drive code estimation section 13 segmentalizes the driving behavior data into a plurality of partial series, and adds a drive code to each of the partial series in accordance with the states of the partial series. As a result, the partial series are converted into drive code strings.

The coding method used in this embodiment is such that part or all of the driving behavior data are vectorized, and the resultant vectors are given the drive codes as identification codes. Each of the vectors may be such that on is represented by 1 and “off” by 0 showing presence or absence of each driving maneuver. Instead of presence or absence of each driving maneuver, a degree of operation of each driving maneuver normalized in the range from 0 to 1 may be used. Since such vectorization method is well known (refer to Japanese Patent No. 5278419, for example), detailed explanation is omitted here.

The drive code database 14 aggregates, for each individual driver, the driving behavior data collected by the driving behavior data collection section 11, frequency distributions of various feature quantities extracted from the driving behavior data and the drive code string formed by the drive code estimation section 13 based on the driver information collected by the driver information collection section 12. Further, the drive code estimation section 14 accumulates resultant frequency distributions of the drive codes and so on while associating them with the driver information. In the following, such information described above is collectively referred to as driving behavior information.

The appearance pattern classification section 15 clusters the driving behavior data using drive code patterns that appear in the driving behavior data of each driver and the driver information to forma plurality of clusters corresponding to driver groups to each of which drivers who are similar in driving behavior belong.

The small cluster database 16 stores the clusters formed by the appearance pattern classification section 15 as small clusters. Further, the small cluster database 16 stores, for each of the small clusters, information for associating drivers with the driving behavior information stored in the drive code database 14 as association information. In the following, the driving behavior information and the association information of each small cluster are collectively referred to as small cluster information.

Next, the small cluster forming process which the appearance pattern classification section 15 performs is explained with reference to the flowchart of FIG. 3. This process is performed at regular time intervals or each time a predetermined amount of data is newly stored.

This process begins in step S110 where a CPU functioning as the appearance pattern classification section 15 calculates a frequency feature quantity for each driver based on the drive code strings, that is, based on the coded driving behavior data stored in the drive code database 14. Specifically, a TF-IDF (Term Frequency-Inverse Document Frequency) feature quantity is calculated for each driver. In calculating the TF-IDF feature quantity, one drive code string is regarded as one sentence, and each of drive codes included in one drive code string is regarded as a word. The TF-IDF feature quantity is represented as a vector formed by the values of the respective drive codes showing their importances. The frequency (TF) of each drive code appearing in each drive code string is weighted by the inverse (IDF) of the frequency by which the drive code is included in the drive codes of other drivers. Accordingly, the importances of the drive codes that appear in the drive code strings of many of the drivers have large values, while the importances of the drive codes that appear in the drive codes of only a small number of specific drivers have small values.

In subsequent step S120, a cosine similarity between each two of the TF-IDF feature quantities calculated in step S110 is calculated as a feature quantity similarity. The cosine similarity takes a value in the range from 0 to 1. The similarity is higher as the value is closer to 1. Instead of such a cosine similarity, Euclid distance or Mahalanobis distances may be used as the feature quantity similarity.

In subsequent step S130, clustering of the TF-IDF feature quantities is performed. This embodiment uses a k-medoids method in which data classification is performed using the feature quantity similarities calculated in step S120 such that the sum of the similarities between the TF-IDF feature quantity and the TF-IDF feature quantity of the cluster center sample for each cluster becomes minimum. Instead of such a k-medoids method, a k-means method, a method using an infinite relational model, or a method of performing clustering through thresholding while setting a threshold to driver attribute information may be used.

In subsequent step S140, the TF-IDF feature quantities and the small clusters formed in step S130 are stored in the small cluster database 16. Then, this process is terminated. Incidentally, since various vectorized driving behavior data are used to form the small clusters, drivers belonging to the same small cluster resemble to one another in driving behavior.

The cluster forming unit 20 includes a classification requirement database 21, a cluster forming process section 22 and a support cluster database 23. The cluster forming unit 20 corresponds to an integration part 20.

The cluster forming process section 22 integrates the small clusters stored in the small cluster database 16 for each kind of drive support such that an integrated cluster satisfies the classification requirement of each kind of drive support stored in the classification requirement database 21. As a result, support clusters having grains appropriate to the respective drive supports are formed. Further, the cluster forming process section 22 performs a process to associate each of the support clusters with an appropriate support mode. Here, the grain means a data amount necessary to form a standard model representing average driving behavior of drivers belonging to the same support cluster at a desired accuracy.

The classification requirement database 21 stores classification requirements which the cluster forming process section 22 uses to determine cluster grain. The classification requirement, which is set for each kind of drive support, defines a feature quantity of interest and determination criteria. The feature quantity is a physical value that can be extracted from the driving behavior data and has a close relationship with the content of the drive support. For example, a time from when a brake pedal starts to be stepped to when a vehicle is stopped, a derivative of a depression amount of an accelerator pedal when a vehicle starts, age of the driver, or a distance traveled in the last one month may be used as the feature quantity.

As the determination criteria, a feature quantity distribution of the driving behavior information can be used for each support cluster. For example, the ratio of an amount of data belonging to a predetermined effective range within the feature quantity distribution to the total amount of data constituting the feature quantity distribution, or a density of data at a portion within the feature quantity distribution may be used. Hereinafter, the determination criteria based on such a ratio is referred to as a first type, and determination criteria based on such a density is referred to as a second type. In the first type, the effective range and a ratio threshold are set for each support mode. In the second type, the density may be a total amount of the data of the feature quantity, or a dispersion of the feature quantity.

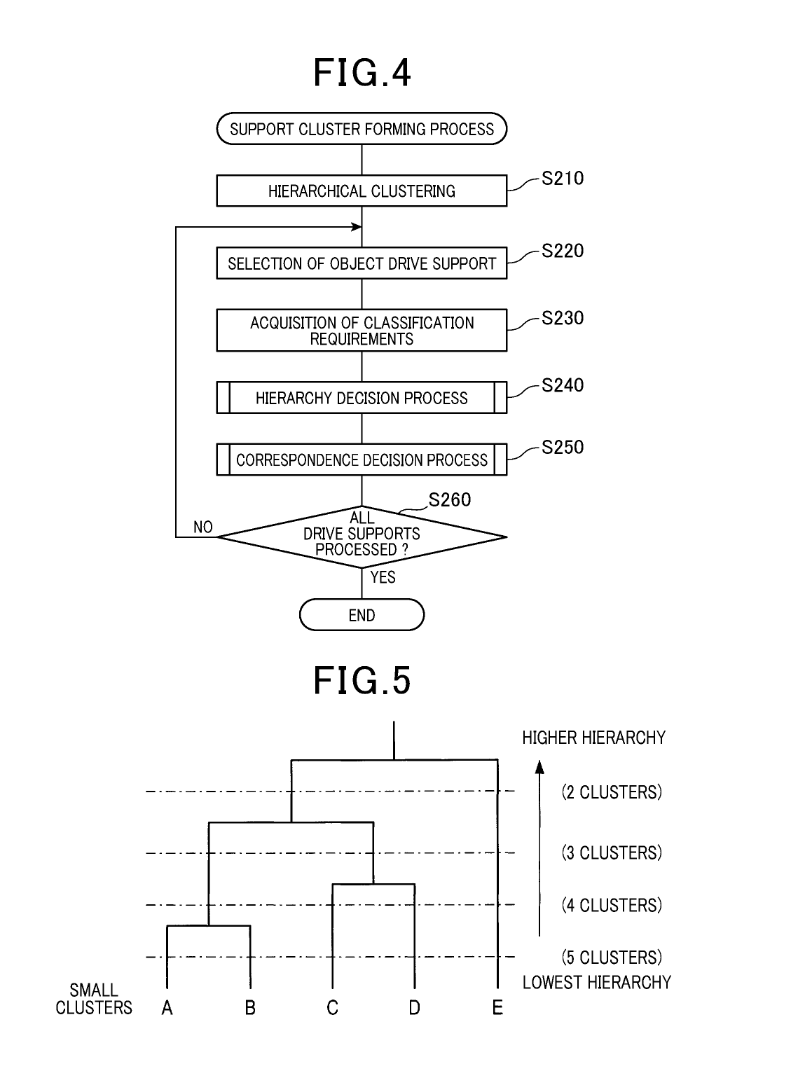

Next, the support cluster forming process performed by the cluster forming process section 22 is explained with reference to the flowchart of FIG. 4. This process is performed at regular time intervals or each time the small cluster database 16 is updated.

This process begins in step S210 where a CPU functioning as the cluster forming process section 22 performs hierarchical clustering using the small clusters stored in the small cluster database 16. In the hierarchical clustering, the small clusters as minimum units are integrated in succession. The progress and result of the hierarchical clustering can be represented as a tree diagram as shown in FIG. 5. In this embodiment, there is used the Ward method in which cluster pairs are merged in succession such that the difference between the cluster dispersion after the integration and the sum of dispersions of the clusters before the integration becomes minimum. Instead of the Ward method, a group average method, a minimum distance method or a maximum distance method may be used. The tree diagram obtained by the hierarchical clustering is stored in the support class database 23.

In subsequent step S220, one of predetermined drive supports is selected as an object support. Here, the term “drive support” means various vehicle control processes or control of vehicle-mounted devices to support a driver to maneuver a vehicle.

In subsequent step S230, the classification requirement corresponding to the object support is acquired from the classification requirement database 21. In subsequent step S240, a hierarchy decision process is performed to decide in which hierarchy the support cluster should be formed based on the result of the hierarchical clustering in step S210.

In subsequent step S250, a correspondence decision process is performed to decide which of the support models of the object support should be associated with each of the support clusters formed in the hierarchy decided in step S240.

In subsequent step S260, it is determined whether or not steps 220 to 250 have been completed for all the drive supports. If the determination result in step S260 is negative, the process returns to step S220, and otherwise the process is terminated.

By performing the support cluster forming process as explained above, the support cluster is determined for each drive support, and also correspondence between the support cluster and the support mode is determined. Step S240 corresponds to a hierarchization part, and step S250 corresponds to a setting part.

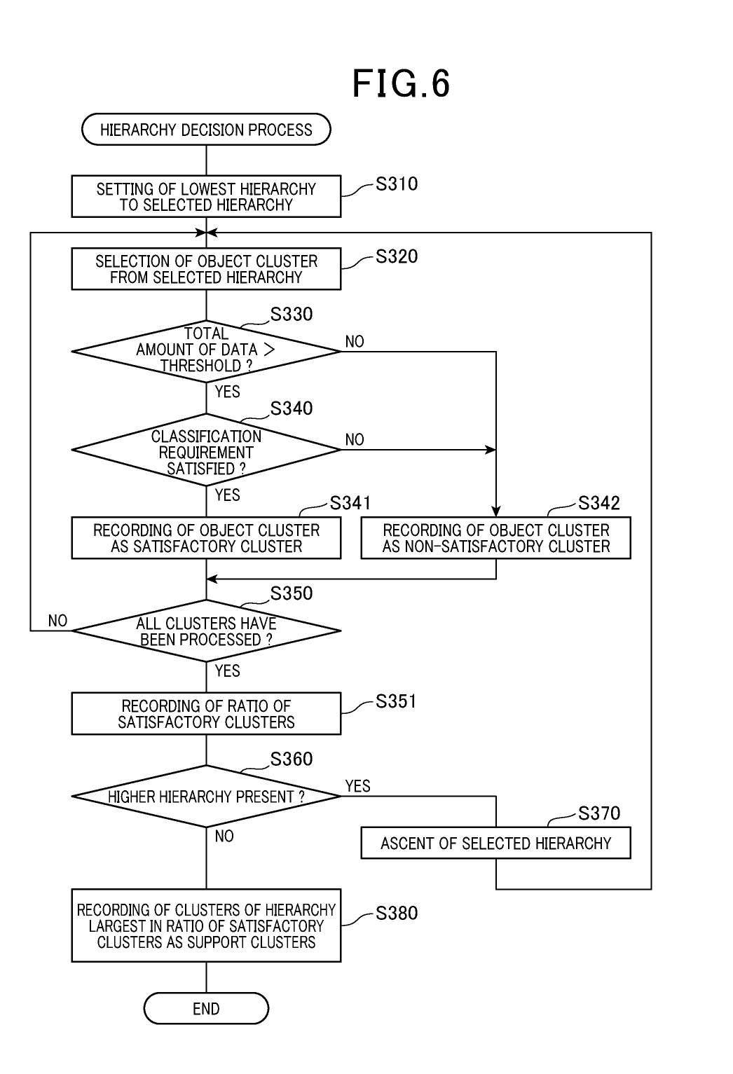

Next, the hierarchy decision process performed in step S240 is explained in detail with reference to the flowchart of FIG. 6. It should be noted that the small clusters may be directly used as the support clusters without performing the hierarchical decision process.

This process begins in step S310 where the lowest cluster hierarchy is set as a selected hierarchy. In subsequent step S320, one of the clusters belonging to the selected hierarchy is selected as an object cluster to be processed.

In subsequent step S330, it is determined whether or not the total amount of data of a requirement feature quantity (the feature quantity acquired as the classification requirement in step S230) exceeds a predetermined total amount threshold. The total amount threshold is not limited to a fixed value common to all the drive supports. It may be set to different values for different ones of the drive supports. If the determination result in step S330 is affirmative the process proceeds to step S340, and otherwise proceeds to step S342.

In step S340, it is determined whether or not the requirement feature quantity of the object cluster satisfies the classification requirement acquired in step S230. If the determination result in step S340 is affirmative, the process proceeds to step S341, and otherwise proceeds to step S342.

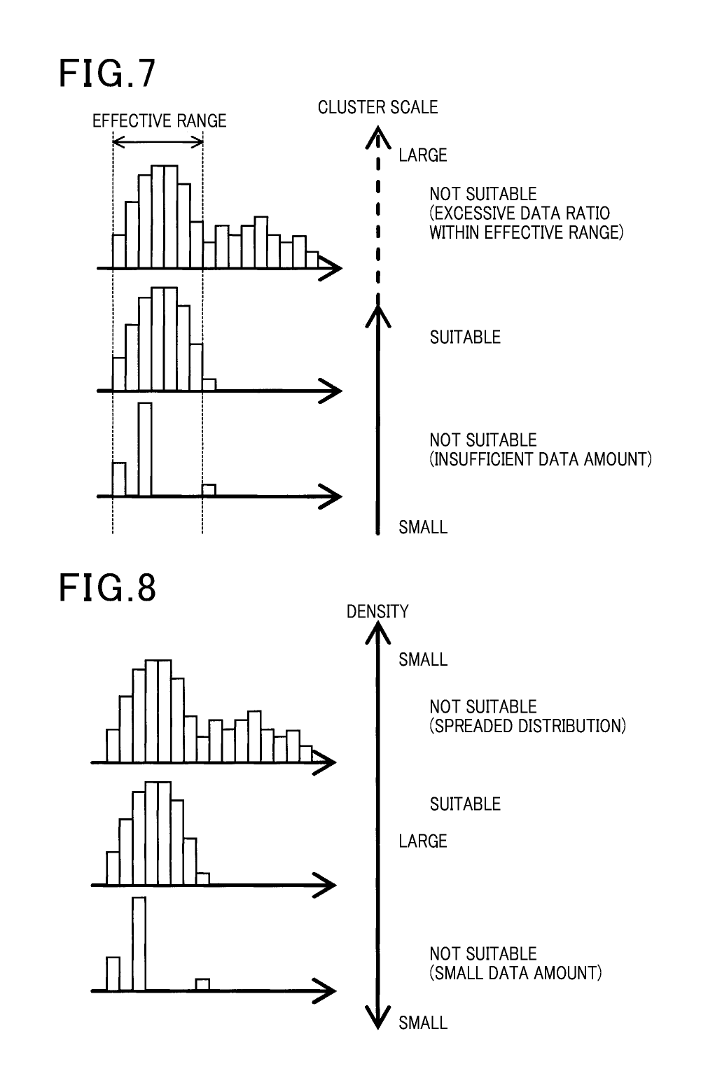

In step S341, the object cluster is recorded as a satisfactory cluster. In step S342, the object cluster is recorded as a non-satisfactory cluster. For example, when the classification requirement is of the first type, a data ratio showing a ratio of the amount of data within the effective range to the total amount of data of the feature quantity distribution is calculated as shown in FIG. 7. If the data ratio is higher than a predetermined ratio threshold, it is determined that the object cluster satisfies the classification requirement. When the object cluster is small in scale, that is, when the amount of data within the effective range is small, or when although the object cluster is sufficiently large in scale, but a large amount of data are present outside the effective range, causing the feature of the distribution to be unclear, it is determined that the object cluster is inappropriate as a support cluster.

On the other hand, as shown in FIG. 8, although an effective range is not set, if data concentrate in a specific range within the feature quantity distribution, and the degree of the concentration is higher than a predetermined concentration threshold, it is determined that the object cluster satisfies the classification requirement.

Thereafter, in step S350, it is determined whether or not all the clusters of the selected hierarchy have undergone the above described process steps. If the determination result in step S350 is negative, the process returns to step S320, and otherwise the process proceeds to step S351.

In step S351, the ratio of the number of the satisfactory clusters to the number of all the clusters in the selected hierarchy is recorded, and then the process proceeds to step S360. In step S360, it is determined whether or not there is a hierarchy higher than the selected hierarchy. If the determination result in step S360 is negative, the process proceeds to step S370 to ascend the selected hierarchy, and then returns to step S320.

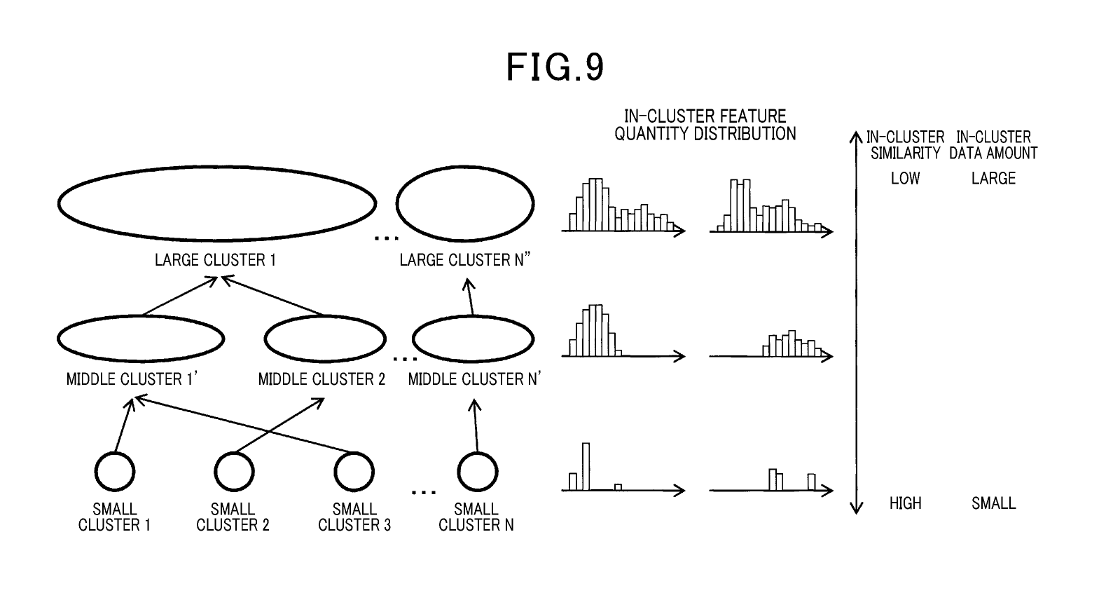

In step S380, the clusters belonging to the hierarchy whose ratio of the satisfactory clusters is the largest are recorded as the support clusters, and then the process is terminated. As shown in FIG. 9, the feature quantity distribution of a cluster belonging to some hierarchy is formed by merging the feature quantity distributions of the immediate lower hierarchies. Accordingly, the amount of accumulated data of a higher hierarchy is larger than that of a lower hierarchy. The similarity of drivers in driving behavior belonging to the same cluster of a higher hierarchy is greater than that of a lower hierarchy. If the clusters of the selected hierarchy satisfy the classification requirement at a degree higher than other hierarchies, the clusters of the selected hierarchy are set as the support clusters. Here, the support clusters are selected from middle clusters of a middle hierarchy each having a moderate amount of data and being clearly distinguishable from one another in feature.

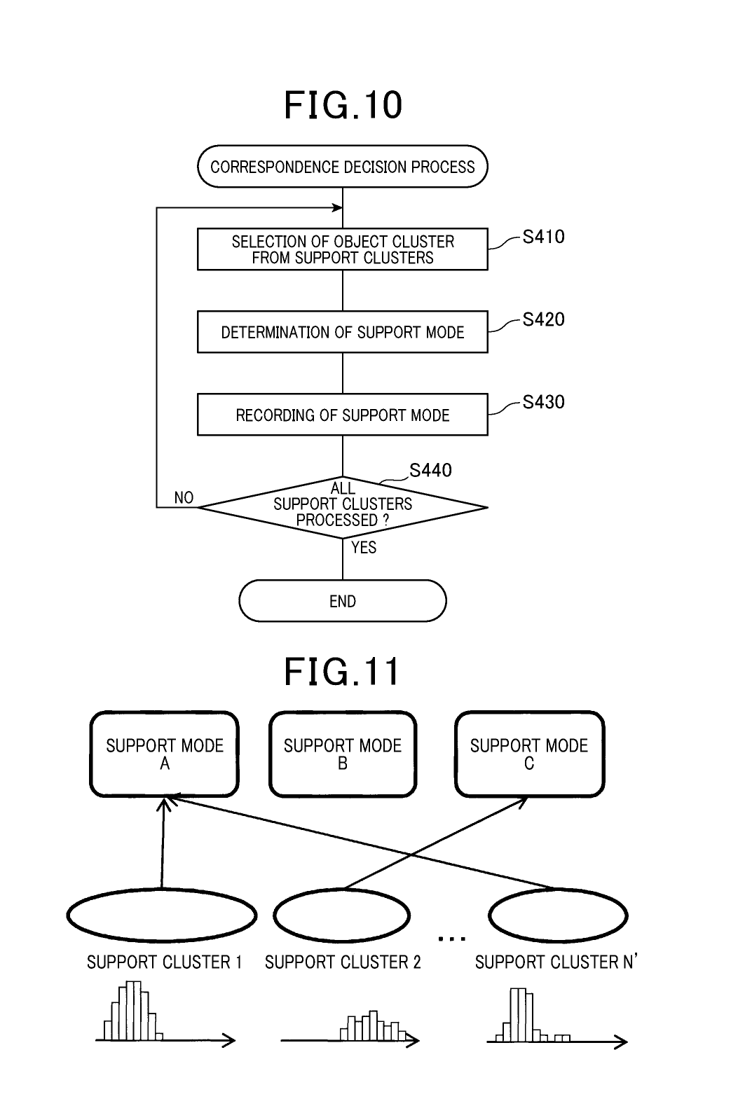

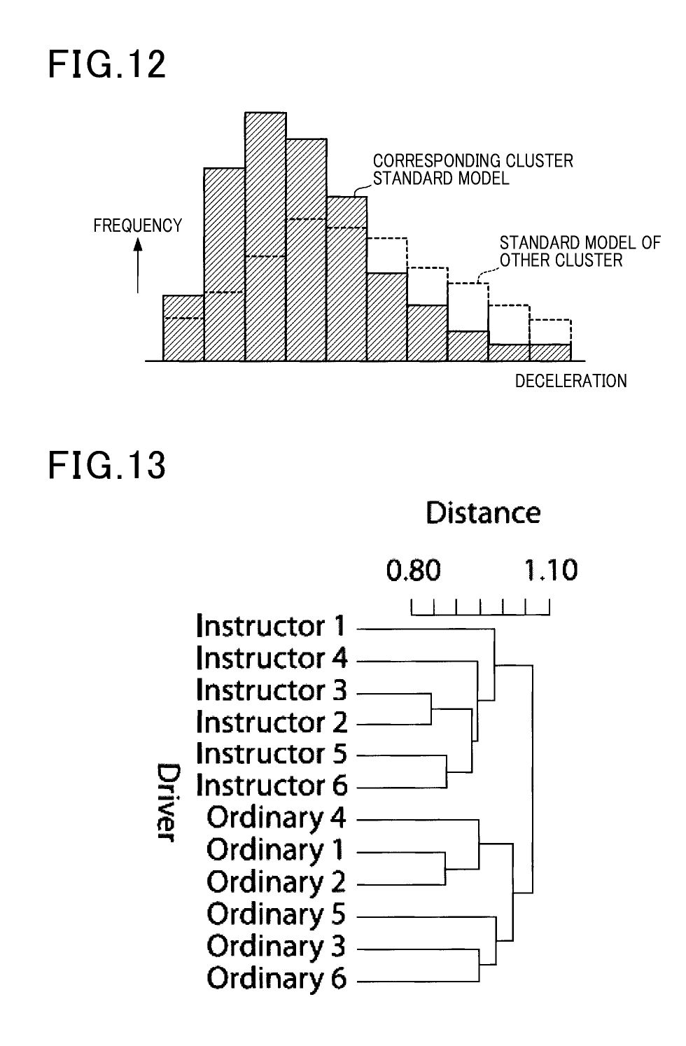

Next, the correspondence decision process performed in step S250 is explained in detail with reference to the flowchart of FIG. 10.

This process begins in step S410 where one of the clusters decided to be the support clusters in step S240 is selected as an object cluster to be processed. In subsequent step S420, correspondence between the support modes and the support clusters are decided. For the classification requirements of the first type, each individual of the support clusters maybe associated with one of the support modes that corresponds to the determination criteria which the individual support cluster satisfies. For example, the support cluster satisfying the determination criteria that a certain amount ratio of data are included in a range where brake timing is late may be associated with a support mode to advance timing to issue warning of a collision with an obstacle. For the classification requirements of the second type, each one of the support clusters maybe associated with one of the support modes. As shown in FIG. 11, two or more of the support clusters may be associated with the same support mode.

In subsequent step S430, the correspondence with the support modes and the support clusters are recorded in the support cluster database 23. Also the feature quantity distributions of the respective support clusters are recorded in the support cluster database 23 as the standard models. In subsequent step S440, it is checked whether or not all the clusters have undergone the above process steps. If the check result in step S440 is negative, the process returns to step S410, and otherwise, the process is terminated.

Next, the support providing unit 30 is explained. The support providing unit 30 includes a driving behavior data acquisition section 31, a drive code estimation section 32, a belonging cluster determination section 33, a support mode determination section 34 and a drive support providing section 35. The driving behavior data acquisition section 31 and the drive code estimation section 32 constitute an object data acquisition part. The belonging cluster determination section 33 constitutes a determination part. The drive support providing section 35 constitutes a support providing part.

The driving behavior data acquisition section 31 acquires at least part of the driving behavior data collected by the driving behavior data collection section 11 repeatedly through various vehicle-mounted sensors or a GPS receiver mounted on the own vehicle. The acquired data is used as object data showing measurement values of the driving behavior of the support object driver.

The drive code estimation section 32 converts the object data acquired by the driving behavior data acquisition section 31 into a drive code string. The belonging cluster determination section 33 estimates a cluster to which the support object driver belongs from the drive code string received from the drive code estimation section 32 in the following way. The belonging cluster determination section 33 aggregates each of the drive codes included in the drive code string received from the drive code estimation section 32 to form a set SX of the drive codes that have appeared in the driving behavior of the support object driver. Next, the belonging cluster determination section 33 calculates the probability p(k|S_{X}) that the object vehicle driver belongs to the small cluster Dₖ for each of all the small clusters D₁ to D_{K}. The belonging cluster determination section 33 identifies the small cluster whose probability p(k|S_{X}) is the largest. The belonging cluster determination section 33 determines that the support cluster to which the identified small cluster belongs is the belonging cluster to which the support object driver belongs based on the tree diagram as the result of the hierarchical clustering.

The support mode determination section 34 acquires the support mode and the standard model associated to the support cluster determined to be the belonging cluster by the belonging cluster determination section 33.

The drive support providing section 35 provides drive support in accordance with the support mode acquired by the support mode determination section 34. The content of the drive support provided may be predetermined for each of the support modes, or may be determined based on the information of the standard model as a parameter. For the case where the drive support corresponds to the classification requirements of the second type, one of the support modes corresponding to the individual cluster is selected to provide drive support assumed to be appropriate to the support object driver using the information of the standard model of the individual cluster.

For example, the drive support using the information of the standard model is to perform control such that acceleration response is reduced when a stepping amount of an accelerator pedal deviates from the accelerator stepping amount distribution of the support cluster to which the support object driver belongs, to thereby prevent an unexpected sudden acceleration due to wrong operation.

It is possible to detect and record driving behaviors of drivers belonging to the same support cluster for various driving scenes, so that a driving behavior of the support object driver in an unexperienced driving scene can be inferred. For example, when the support object driver is driving a vehicle on a curved road where drivers belonging to the same support cluster are likely to deviate from a driving lane, a warning to reduce the speed may be issued before the vehicle enters the curved road. Further, it is possible to compare the standard model of the belonging cluster to which the support object driver belongs with the standard models of the clusters other than the belonging cluster for detecting lowering of the driving ability peculiar to the belonging cluster, and to provide a drive support to make up for the lowering of the driving ability.

It is also possible to obtain information of distributions or representative values of age, driving experience or driving frequency of drivers belonging to the belonging cluster based on the driver information, and indicate such information in an information display device such as a headup display, a car navigation or a smart phone. In this case, since the driver information of the drivers who resemble in driving behavior to the support object driver are indicated, the support object driver can objectively recognize lowering of the driving ability.

The drive support apparatus 1 according to the embodiment described above provides the following advantages. The drive support apparatus 1 is configured to form the small clusters to each of which drivers who resemble to one another in driving behavior belong, and form the support clusters by integrating the small clusters as appropriate using the feature quantities in accordance with the contents of the drive supports. As a result, the support object driver can be provided with an appropriate drive support in accordance with the tendency in driving behavior of the support object driver.

The drive support apparatus 1 is configured to determine which of the hierarchical clusters should be used as the support clusters for each kind of the drive supports by using the hierarchized clusters formed by hierarchy-clustering the small clusters. That is, all the support clusters used to provide drive support are set to have grains appropriate to the drive support in accordance with the degree of accumulation of information necessary for the drive support. Accordingly, even when an amount of data regarding the support object driver is small, it is possible to provide the support object driver with an appropriate drive support by using the information of other drivers belonging to the same support cluster as the support object driver.

The results of the hierarchal clustering can be used for various drive supports. That is, just by appropriately setting the criteria for determining which of the hierarchies should be used for each drive support, it becomes possible to form the support clusters which are respectively suited to the drive supports. Therefore, according to the embodiment, it is possible to exactly determine the support cluster to which the support object driver belongs, to provide an exact drive support in accordance with the determined support cluster.

The drive support apparatus 1 uses, as the classification requirement of the first type, the requirement that the data ratio within the effective range in the feature quantity distribution is higher than the predetermined ratio threshold. Accordingly, in the case where the number of the support modes and the support characteristics of each mode are predetermined, it is possible to form the support clusters which are respectively suited to the drive supports. For example, for a driver who is not good at merging operation with other traffic, the drive support apparatus 1 can support the driver to perform a merging operation.

The drive support apparatus 1 uses, as the classification requirement of the second type, the requirement that the feature quantity distribution has a specific range therein where data density is high. Accordingly, in the case where the number of the support modes is variable, however, the cluster feature quantity distribution should have a specific range where data density is high therein, it is possible to form the support clusters respectively suited to the drive supports. For example, it is possible to detect deviation from the standard model of the belonging cluster, and determine a compensation value in accordance with the deviation.

The drive support apparatus 1 forms the small clusters using the driving behavior data having been converted into a drive code string. This makes it possible to classify drivers in accordance with general characteristics of the drivers.

The drive support apparatus 1 forms the support clusters for each of the respective drive supports using the feature quantity distributions extracted from the driving behavior data. This makes it possible to perform classification in accordance with the characteristics of the respective drive supports.

FIG. 13 shows a result of clustering of driving behavior data of drivers including instructors of driving schools and ordinary drivers. In FIG. 13, the word “Distance” means an inter-cluster distance. As seen from FIG. 13, to provide a drive support in accordance with driving skill, the clusters of the highest hierarchy are set as the support clusters shown by the broken line in FIG. 13.

It is a matter of course that various modifications can be made to the above described embodiment as described below.

The drive code estimation section 13 uses, as a method of coding the driving behavior data, a vectorization method. However, any other appropriate method may be used. For example, there may be used a technique in which the driving behavior data is segmentalized into a plurality of partial series each representing some drive scene, and each of the partial series is given an identification code by using a DAA (Double Articulation Analyzer). For detail of the DAA, refer to T. Taniguchi et al “Semiotic Prediction of Driving Behavior using Unsupervised Double Articulation Analyzer” IEEE Intelligent Vehicles Symposium, 2012, or K. Takenaka et al “Contextual Scene Segmentation of Driving Behavior based on Double Articulation Analyzer” IEEE/RSJ International Conference on Intelligent Robots and Systems, 2012, for example.

In the above embodiment, the cluster forming unit 20 is connected to a communication network like the data collection/storage unit 10. However, the cluster forming unit 20 may be mounted on each vehicle together with the support providing unit 30.

In the above embodiment, the appearance pattern classification section 15 performs clustering to form the small clusters. However, it is possible to directly associate individual drivers with the small clusters without performing clustering.

The above explained preferred embodiments are exemplary of the invention of the present application which is described solely by the claims appended below. It should be understood that modifications of the preferred embodiments may be made as would occur to one of skill in the art.

What is claimed is:

1. A drive support apparatus comprising:
a data collection part that collects, as driving behavior data, data showing driving maneuvers performed by drivers and data showing vehicle behaviors due to the driving maneuvers;
a classification part that performs clustering of the driving behavior data to form small clusters to each showing tendency of driving behavior of the drivers belonging thereto, and stores small cluster information representing characteristics in driving behavior of the drivers for each of the small clusters;
an integration part that integrates, in accordance with contents of predetermined drive supports to control a vehicle or to control devices mounted on the vehicle, the small clusters to thereby form support clusters each showing tendency of driving behavior of the drivers for each kind of the drive supports, and stores, as support cluster information, the small cluster information for each of the support clusters;
an object data acquisition part that acquires, as object data, the driving behavior data regarding a support object driver to be supported;
an estimation part that estimates, as a belonging cluster, one of the support clusters to which the support object driver belongs for each kind of the drive supports by comparing the object data with the support cluster information accumulated by the integration part; and
a support providing part that provides the support object driver with at least one of the drive supports which has a content associated to the belonging cluster.

2. The drive support apparatus according to claim 1, wherein
the integration part includes a hierarchization part that performs hierarchal clustering of the small clusters to form hierarchized clusters in a hierarchical structure having a plurality of hierarchies, and
a setting part that sets, as the support cluster to be used for providing an object drive support which is one of the drive supports, the hierarchized clusters belonging to a selected one of the hierarchies, which is highest of all the hierarchies in a ratio by which predetermined classification requirements to determine whether the hierarchized clusters belonging to the selected hierarchy are suitable for the object drive support are satisfied.

3. The drive support apparatus according to claim 2, wherein the setting part uses a feature quantity distribution accumulated as support cluster information for each kind of the contents of the drive supports to determine whether the hierarchized clusters belonging to the selected hierarchy are suitable for the object drive support.

4. The drive support apparatus according to claim 3, wherein the setting part uses, as one of the classification requirements, that an amount ratio of data included in a predetermined effective range in the feature quantity distribution is higher than a predetermined ratio threshold.

5. The drive support apparatus according to claim 3, wherein the setting part uses, as one of the classification requirements, that a data density of a specific range of the feature quantity distribution is higher than a predetermined density threshold.

6. The drive support apparatus according to claim 4, wherein the setting part allows to make a determination of whether the classification requirements are satisfied when a total amount of data constituting the feature quantity distribution is large than a predetermined threshold.

7. The drive support apparatus according to claim 2, wherein the hierarchization part uses the Ward method to perform the hierarchical clustering.

8. The drive support apparatus according to claim 1, wherein the data collection part segmentalizes a data series showing states of detected driving behaviors of the drivers into a plurality of partial series, and add a drive code to each of the partial series in accordance with states of the partial series to thereby form the driving behavior data,
an appearance pattern of the drive codes formed for each of the drivers being used as the feature quantity distribution for the estimation by the estimation part.

9. The drive support apparatus according to claim 1, further comprising a driver information collection part that acquires driver information including at least one of age, driving experience and driving frequency of each of the drivers while associating the driver information with the driving behavior data acquired by the data collection part,
the support providing part being configured to display a representative value of characteristics of the drivers belonging to the belonging cluster based on the driver information collected by the driver information collection part.

10. The drive support apparatus according to claim 1, wherein the support providing part compares an average driving behavior of the drivers belonging to the belonging cluster with average driving behaviors of the drivers belonging to the support clusters other than the belonging cluster to determine a content of the drive support to be provided to the support object driver in accordance with a deviation therebetween.
